(19) United States
(12) Patent Application Publication
(10) Pub. No.: US 2002/0052804 A1
(43) Pub. Date: May 2, 2002

(54) Network website system for assisting a vendee to design a gift

(75) Inventor: Jung-Hwa Yang, Taipei (TW)

Correspondence Address: ARENT FOX KINTNER PLOTKIN & KAHN, 1050 CONNECTICUT AVENUE, N.W., SUITE 600, WASHINGTON, DC, 20036, US

(73) Assignee: E-ASAP CORPORATION

(21) Appl. No.: 09/750,355

(22) Filed: Dec. 29, 2000

(30) Foreign Application Priority Data
Oct. 30, 2000 (TW) 089122850

(51) Int. Cl. G06F 17/60

(52) U.S. Cl. 705/27

(57) ABSTRACT

The present invention provides a network website system for assisting a vendee to design a gift. The network website system classifies and stores the merchandise data provided by vendor members in a predetermined way. When a vendee enters the network website system, he or she may choose not only to be assisted in selecting the merchandise, but also to design the merchandise provided by vendor members in order to make the merchandise have distinguishing features. It allows buyers to save the purchasing time and cost when using this network website system.

### FIELD OF THE INVENTION

The present invention relates to a network website system, and especially to a network website system for assisting a vendee to design a gift.

### BACKGROUND OF THE INVENTION

When it comes to marketing strategies of a business entity, types of gifts and schemes to make use of gifts usually play very important roles. A business entity usually designs or selects appropriate merchandise as his promotion gifts in order to show the features of merchandise the business entity sells. Those gifts are not selected from the off-the-rack products, but instead, are designed in accordance with the demand and the image of a business entity. Selecting appropriate gifts not only consolidates the image that a business entity gives to the general public, but also creates many other business opportunities.

Recently the development of the corporate identification system has become a trend. However, if a business entity sets up an additional department or increases manpower to work on developing the promotion gifts, it will apparently cause much unnecessary resource waste. If authorizing a gift design company to prepare the gifts, a business entity not only saves the cost, but also receives professional designs and perfect services. A gift design company may also create the unique corporate-identifying trademark for a business entity by drawing on collective wisdom and absorbing all useful ideas.

Generally, a gift design company needs to collect information and provide a variety of merchandise for customers to choose from. Besides, much labor is to be consumed to compare the price of the merchandise in all respects. However, the final results usually neglect the uniqueness of the customers and forget about the original purpose of product marketing. Therefore, the traditional method may not be able to satisfy the customers while wasting much time and money. In addition, before the style and pattern of the designs are determined, it is not easy to describe them precisely by words. Therefore the customers tend to misunderstand what the designers think and vice versa. It also takes too much time for both parties to come to an agreement.

Consequently, a network website system for assisting a vendee to design a gift is being introduced hereinafter to solve the aforementioned problem.

### SUMMARY OF THE INVENTION

The purpose of the present invention is to provide a network website system for assisting a vendee to design a gift. It allows the vendee members to design desired promotion gifts in order to have unique and satisfactory gifts.

In order to achieve the above purpose, the network website system of the present invention includes a register mechanism for allowing new members to log on and building up member information, a receiving mechanism for receiving information and graphs uploaded by vendee members and vendor members, a member database for storing membership-related data according to a predetermined category, a merchandise database for storing merchandise-related data provided by vendor members according to a predetermined category, a design database for providing various design information, a DIY mechanism for assisting vendee members to design the desired gifts, and a consulting mechanism for providing predetermined questionnaires for vendee members to determine desired style of merchandise. If vendee members are not satisfied with all merchandise in the merchandise database, the website system of the present invention will further provide a bidding mechanism for vendee members to announce their criteria of desired merchandise and receive corresponding response from any vendor member who is interested in the bid. The website system also includes a purchase order generating mechanism for generating a purchase order in accordance with vendee members' selection. Wherein the network website system will select the suitable merchandise according to the purchase order decided by the vendee members. The purchase order will then be transferred to the vendor members who provide the suitable merchandise. After the purchase order is determined, the automatic price report mechanism of the website system will calculate the total amount the purchase order to be worth and transfer the total amount to the vendee members.

### BRIEF DESCRIPTION OF THE DRAWING

FIG. 1 illustrates the environment of the network website system in accordance with the present invention.

FIG. 2 illustrates the structure of the web server in accordance with the present invention.

FIG. 3 shows the flow chart of the network website system in accordance with the present invention.

FIG. 4 shows the flow chart of the network website system when assisting vendee members to decide the desired merchandise.

### DETAILED DESCRIPTION OF THE PRESENT INVENTION

The present invention provides a network website for assisting a vendee to design a gift. The preferred embodiment of the present invention is described hereinafter.

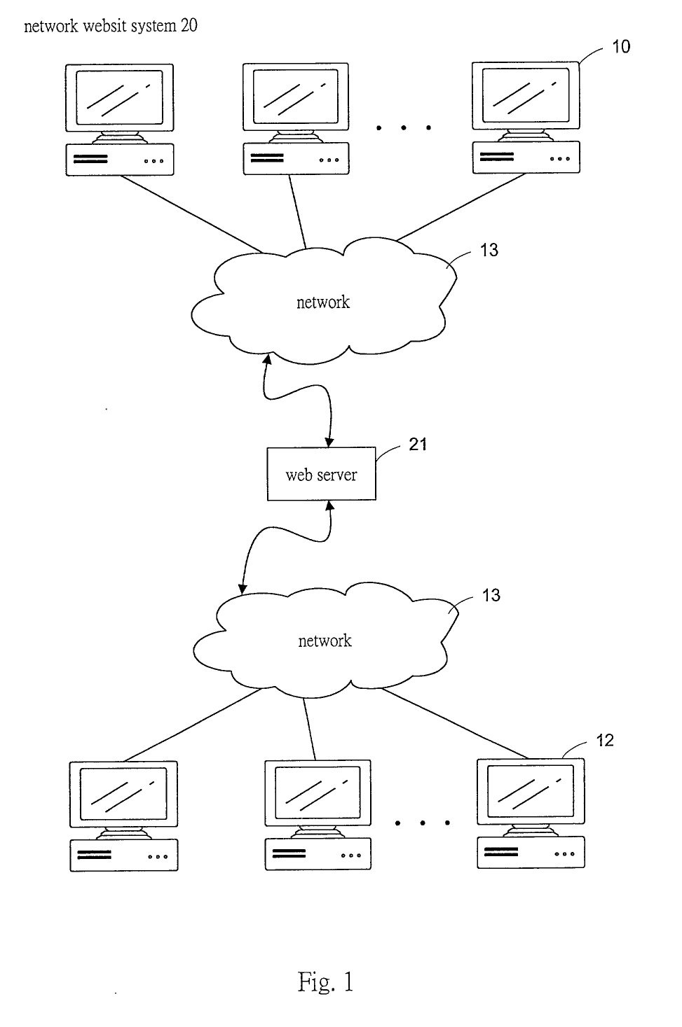

FIG. 1 illustrates the environment of the website system 20 in accordance with the present invention. In the preferred embodiment, a plurality of vendor members 12 is connected to the web server 21 of the present invention by means of a network 13. In a similar way, a plurality of vendee members 10 is also connected to the web server 21 by means of the network 13 in order to browse the information of all merchandise and to order the required merchandise. The aforementioned network 13 includes the computer communication network, the telecommunication network, the wireless communication network, and the cable television network, etc. When utilizing the structure of the computer communication network, vendee members 10 and vendor members 12 usually need to be equipped with computers with browsers installed.

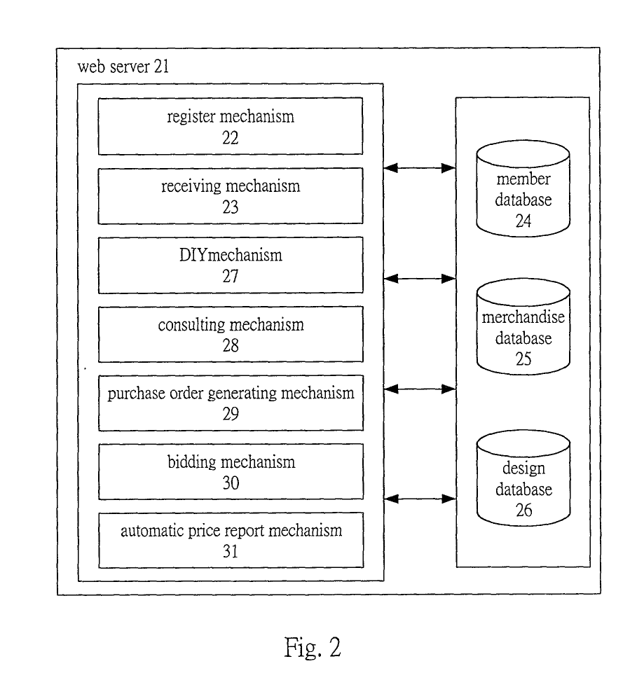

FIG. 2 illustrates the structure of the web server 21 in accordance with the present invention. The web server 21 includes a register mechanism 22, a receiving mechanism 23, a member database 24, a merchandise database 25, a design database 26, a DIY mechanism 27, a consulting mechanism 28, a purchase order generating mechanism 29, a bidding mechanism 30, and an automatic price report mechanism 31. The register mechanism 22 allows vendee members 10 and vendor members 12 to log on to the web server 21 and build up membership-related data. The member database 24 stores the membership-related data. The receiving mechanism 23 receives data and graphs uploaded by vendee members 10 and vendor members 12. The merchandise database 25 stores merchandise data provided by vendor members 12 in a predetermined way and provides the merchandise data to vendee members 10. The DIY mechanism 27 assists vendee members 10 to design desired style of merchandise. The design database 26 provides colors, patterns or wordings as reference for vendee members 10 to search for desired style of merchandise. The consulting mechanism 28 provides predetermined questionnaires for vendee members 10 to determine desired merchandise. The purchase order generating mechanism 29 generates a purchase order in accordance with selections of vendee members 10, and transfers the purchase order to vendor members 12 who can provide suitable merchandise. The bidding mechanism 30 is for vendee members 10 to announce their criteria of desired merchandise and receive corresponding response from any vendor member 12 who is interested in the bid. The automatic price report mechanism 31 calculates the total amount the purchase order to be worth and transfers the total amount to vendee members 10.

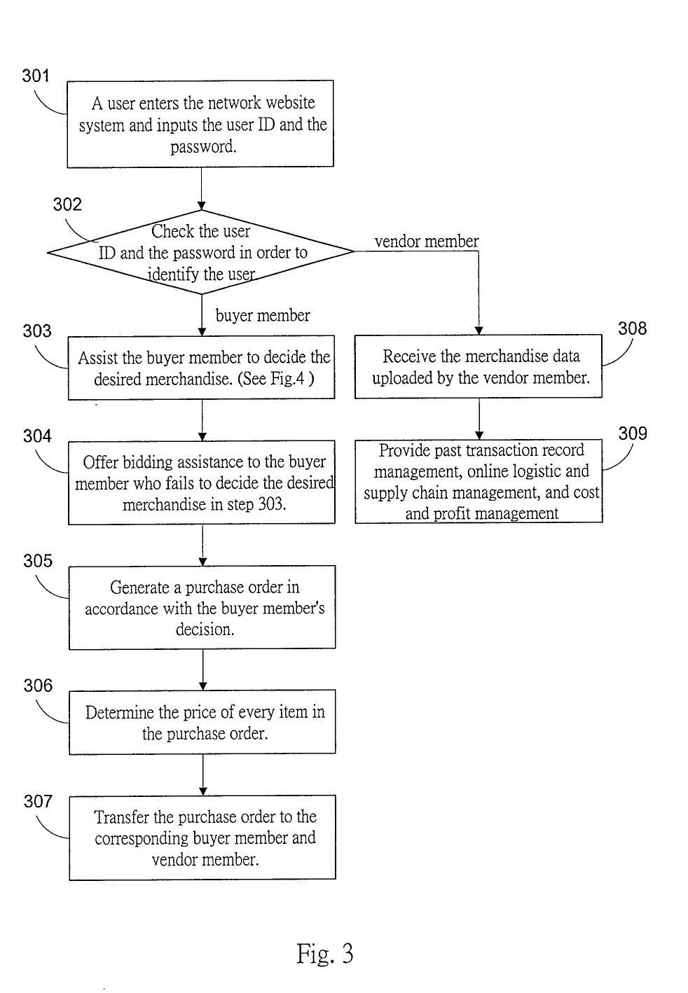

FIG. 3 shows the flow chart of the network website system in accordance with the present invention. The operation steps of the present invention are described as follow.

Step 301—A user enters the network website system 20 and inputs the user ID and the password.

Step 302—The user ID and the password are verified by the register mechanism 22 in order to identify the user. If the user is a vendee member 10, go to step 303. If the user is a vendor member 12, then go to step 308.

Step 303—Assist the vendee member 10 to decide the desired merchandise by means of the DIY mechanism 27 and the consulting mechanism 28.

Step 304—If the vendee member 10 fails to decide the desired merchandise in step 303, the website system will offer bidding assistance for the vendee member to announce his/her own criteria of the merchandise.

Step 305—Generate a purchase order according to the decision of the vendee member 10 by means of the purchase order generating mechanism 29.

Step 306—Determine the price of every item in the purchase order by referring to the data in the merchandise database 25.

Step 307—Transfer the purchase order to the corresponding vendee member 10 and vendor members 12.

Step 308—Receive the merchandise data uploaded by the vendor member 12 by means of the upload receiving mechanism 23, and store the merchandise data according to different categories in the merchandise database 25.

Step 309—Provide past transaction record management, online logistic and supply chain management, and cost and profit management to the vendor member 12.

Please refer to FIG. 2 and FIG. 3. In step 301, any first time user of the network website system 20 has to log on to the web server 21 via the register mechanism 22 so as to register as a new member and allow the system to build up the membership-related data. The membership-related data includes company-related data, order records, and query records, etc. The network website system 20 stores all membership-related data in the member database 24 according to a predetermined category. When entering the network website system of the present invention next time, the user will have to inputs the user ID and the password which are assigned to the user during his/her first log-on. In step 302, the register mechanism 22 verifies the user ID and the password in order to identify the members of the network website system. The register mechanism 22 may use different user IDs to identify different members (e.g. the initial B for the vendee members and the initial V for the vendor members).

In step 308 for the vendor members 12, the receiving mechanism 23 of the web server 21 receives the merchandise-related data provided by all vendor members 12, and saves the data in the merchandise database 25. The merchandise-related data include the price of the merchandise, the description of the merchandise, and the discount of the merchandise, etc. In order to let the vendee members 10 easily select suitable gifts from the merchandise database 25, and to let the system be easily managed, the merchandise data provided by all vendor members 23 are stored in the merchandise database 25 according to predetermined categories. The merchandise database 25 is provided for the vendee members 10 to make selections in accordance with the classification of the merchandise, the price level of the merchandise, or the motive on selecting the merchandise. In step 309, the network website system 20 may also provide the vendor members 12 with the ability to manage the online logistic and supply chain, the cost and profit, and the transaction records, etc. The aforementioned vendor membership-related data is stored in the corresponding section of the member database 24.

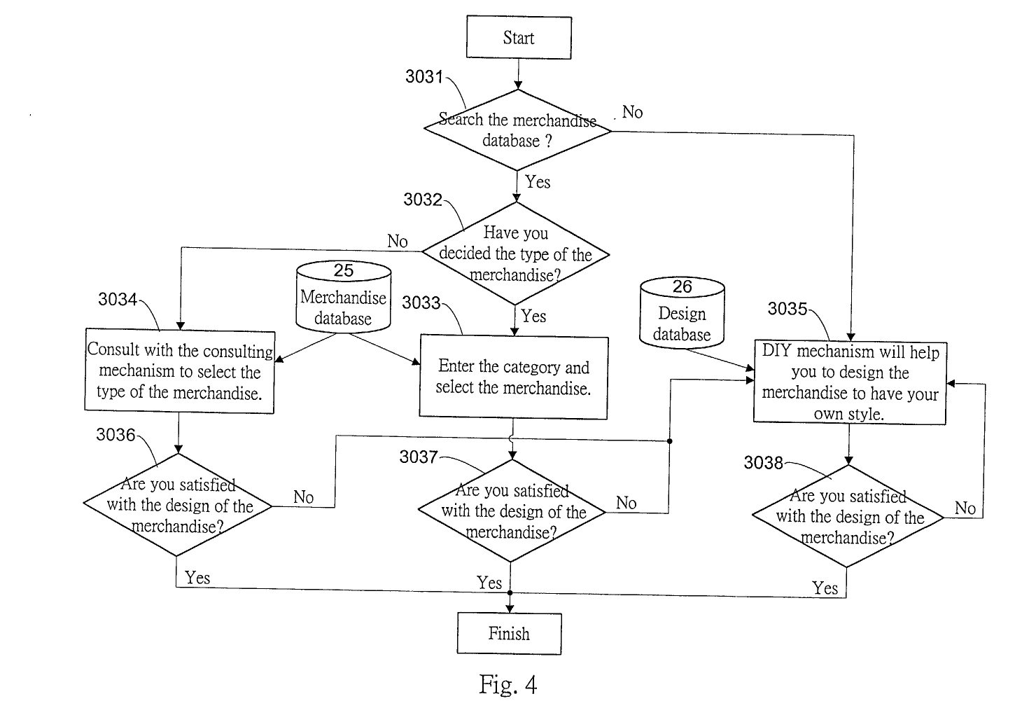

For the vendee members 10, on the other hand, the network website system 20 may provide even more functions. After the IDs have been verified by the register mechanism 22, the vendee members 10 may start to select the merchandise and the assistance. Step 303 further includes more moves as illustrated in FIG. 4. In Step 3031, for example, if a vendee member 10 wants to select a product, he/she may decide whether to order a product which is already in the merchandise database 25 or to design a product of his or her own style. If the vendee member 10 decides to search the merchandise database 25, then the flow chart moves to step 3032, where he/she may still have two choices. First, if the vendee member is very sure about what he/she is going to purchase, he/she may directly enter the well-classified merchandise database 25 to search for desired products as described in step 3033. However, if the vendee member has not decided what to purchase, he/she may use the consulting mechanism 28 to select the satisfying product as specified in step 3034. The consulting mechanism 28 may provide a plurality of predetermined questionnaires so that the vendee members 10 are able to determine the desired style of the merchandise step by step. After the vendee members 10 have finished the questionnaires and decided the style of the products, the consulting mechanism 28 will search for the suitable merchandise from the merchandise database 25.

In step 3031, if the vendee member 10 prefers to design his/her own merchandise instead of searching the merchandise database, then the flow chart moves to step 3035, where the DIY mechanism 27 may help him/her to design the merchandise. In addition, if the vendee member 10 in step 3036, step 3037 and step 3038 is not satisfied with the current design of the existing merchandise, such as the pattern, color, or wording of the merchandise, he/she may also moves to step 3035 and enable the DIY mechanism 27 to design his/her own pattern, marks, or sizes etc. of the merchandise. This will reduce the communication time resulted from different design concepts between two parties. When designing the merchandise, the vendee member 10 may consult the design database 26 for various related design data. Now please refer to FIG. 3. In step 304, if in any way the vendee member 10 is not satisfied with the merchandise, he/she may select the bidding mechanism 30 to announce the criteria of the desired merchandise and receive the responses from the vendor members 12 so that the vendee member 10 is able to compare the price. Therefore, the vendee member 10 may obtain the information of the suggested merchandise and its price. This allows the vendee members 10 to select the most suitable products as the gifts.

In step 305, no matter what kind of method the vendee member 10 chooses to determine the merchandise, the purchase order generating mechanism 29 of the web server 21 will generate a purchase order in accordance with the selection of the vendee member 10. In step 306, when the vendee member 10 decides the content of the purchase order, the automatic price report mechanism 31 of the web server 21 will calculate the total price of the merchandise on the purchase order according to the data in the merchandise database 25. After the vendee member 10 replies to confirm the price report, the network website system 20 will transfer the result of the price report to the vendor members 12 who provide those selected items as specified in step 307. The price report will be saved respectively in the vendee member section and in the vendor member section of the member database 24.

Besides, the network website system 20 may also provide special functions to some specific vendee members 10 with complicated requirements. The register mechanism 22 may assign different user IDs to these specific vendee members 10 in order to distinguish them from general vendee members 10. For example, the specific vendee members 10 such as some big enterprises may have already designed their own patterns or wordings, and they may want to adopt those patterns or wordings when designing their gifts. In that case, the receiving mechanism 23 of the web server 21 may receive the uploaded patterns or wordings from the vendee members 10. Those patterns or wordings will be stored in a predetermined section of the design database 26 so that the vendee members 10 may easily search for those patterns or wordings next time. The network website system 20 of the present invention functions just like a virtual gift design department for those specific vendee members 10. Hence, those specific vendee members 10 not only save much time and effort spent on gift selection, but also acquire assistance from the professionals.

Please be noted that the present invention is not to be limited by the aforementioned embodiment. For example, the transmission method of the price report, the consulting items, and the transaction process etc. are of utility and may be employed without reference to other features and sub-combination as they are outlined within the claims. While the preferred embodiment and application of the invention has been described, it is apparent to those skilled in the art that the objects and features of the present invention are only limited as set forth in claims attached hereto.

What is claimed is:

1. In a network website system for assisting a vendee to design a gift, said network website system comprising a plurality of vendee members and a plurality of vendor members communicating with a web server via a network, said web server comprising:
a register mechanism for allowing said plurality of vendee members and said plurality of vendor members to log on and for building up membership-related data;
a member database, connected to said register mechanism, for storing said membership-related data;
a receiving mechanism for receiving data and graphs uploaded by said plurality vendee members and said plurality of vendor members;
a merchandise database, connected to said receiving mechanism for storing merchandise data supplied by said plurality of vendor members in a predetermined way and providing said merchandise data to said plurality of vendee members;
a design database for providing a plurality of basic design elements;
a DIY mechanism, connected to said design database, for assisting said plurality of vendee members to design a desired style of merchandise based on said plurality of basic design elements; and
a consulting mechanism for providing a plurality of predetermined questionnaires to said plurality of vendee members to select a desired style of merchandise.

2. The web server of claim 1, wherein said web server further comprising a purchase order generating mechanism generating a purchase order in accordance with selections of each of said plurality of vendee members, and transferring said purchase order to said plurality of vendor members who provide suitable merchandise.

3. The web server of claim 1, wherein said web server further comprising a bidding mechanism for said plurality of vendee members to announce criteria of desired merchandise and receive corresponding response from any of said plurality of vendor members.

4. The web server of claim 1, wherein said web server further comprising an automatic price report mechanism, as said purchase order being determined, said automatic price report mechanism calculating a total amount which said purchase order to be worth according to said merchandise data stored in said merchandise database, and transferring said total amount to said plurality of vendee members.

5. The web server of claim 1, wherein said membership-related data comprising corporation-related data, purchase records, and consulting records.

6. A method for assisting a vendee to design a gift over a network including a network website system, said network website system comprising a plurality of vendee members and a plurality of vendor members communicating with a web server via the network, said method comprising:
deciding whether a log-on user is a vendee member or a vendor member; if said user is a vendee member, assisting said vendee member to decide a desired merchandise;
if said user is a vendor member, receiving merchandise data uploaded from the vendor members and providing online logistic and supply chain management, cost and profit management, and transaction record management to said vendor member.

7. The method of claim 6, wherein as assisting said vendee member to decide desired type and style of merchandise, said method further comprising:
providing design database as reference for said vendee member to search for desired style of merchandise.

8. The method of claim 6, wherein as assisting said vendee member to decide desired type and style of merchandise, said method further comprising:
providing a plurality of predetermined questionnaires for said vendee member to determine desired style of merchandise.

9. The method of claim 6, wherein said method further comprising:
generating a purchase order in accordance with selections of said vendee member and transferring said purchase order to a plurality of said vendor members who provide suitable merchandise.

10. The method of claim 6, wherein said method further comprising:
enabling said vendee member to announce criteria of desired merchandise and receive corresponding response from a plurality of said vendor member.

11. The method of claim 6, wherein said method further comprising:
calculating a total amount which said purchase order to be worth according to selections of said vendee member, and transferring said total amount to a plurality of said vendor members.
